(19) United States
(12) Patent Application Publication
(10) Pub. No.: US 2006/0048604 A1
(43) Pub. Date: Mar. 9, 2006

(54) Cemented carbide

(75) Inventors: Susanne Norgren, Huddinge (SE); Mikael Christensen, Goteborg (SE); Goran Wahnstrom, Goteborg (SE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SANDVIK AB, Sandviken (SE)

(21) Appl. No.: 11/110,880

(22) Filed: Apr. 21, 2005

(30) Foreign Application Priority Data
Apr. 22, 2004 (SE) SE 0401037-7

(51) Int. Cl. C22C 32/00; B32B 9/00

(52) U.S. Cl. 75/241; 428/539.5; 428/698

(57) ABSTRACT

The present invention relates to a cemented carbide body containing from about 3 to less than about 15 wt-% binder phase and essentially WC as the remainder. By alloying the binder phase with from about 0.5 to about 15 wt-% Mn an increase in the strength of the WC/WC grain boundaries is obtained.

### BACKGROUND OF THE INVENTION

The present invention relates to a WC based cemented carbide with improved properties. By adding manganese to the binder phase, it has been found possible to obtain strengthened hardphase grain boundaries.

In all polycrystalline materials, the cohesion between grains is of vital importance for their strength and ductility. This applies in particular to sintered materials like cemented carbides where good adhesion between the hard and metal phases also is a prerequisite for densification during sintering. Therefore much effort is made to find ways to improve the interface interactions in the materials. This includes changing the amount of binder phase or using various metal-carbide additives most often on a purely empirical basis. Interfacial strength is sensitive to the atomistic details at the boundaries and often small amounts of interfacial segregated impurity atoms cause intergranular embrittlement in polycrystalline materials. Other additives may enhance the cohesion so a predictive theory of the influence of segregation on grain boundary cohesion is highly desired.

Transition metal carbides such as Cr₃C₂ and/or VC are often added to WC—Co cemented carbides as grain growth inhibitor(s). A fine and homogeneous microstructure is advantageous for the mechanical properties such as hardness of the material. It is obtained by segregation to interfaces and concomitant alteration of the interfacial chemistry. Observations by high resolution electron microscopy of alloys with additions of chromium or vanadium have indicated the presence of thin layers of mixed (VW) Cₓ carbides in the Co/WC interfaces. WC has a hexagonal structure and planar boundaries related to the prismatic and basal planes are frequently found in the cemented carbide. Many of these are characterized by very low index coincidence orientations. Carbide compounds precipitate on the basal and prismatic facets adopting a near coincidence orientation relationship. Thin layers of (VW) Cₓ have also been observed in randomly oriented carbide-carbide grain boundaries.

U.S. Pat. No. 2,018,752 discloses a cemented carbide with 50-80% WC in a binder phase containing metals from the chromium group (Cr, W, Mo or U) and the iron group (Fe, Mn, Ni or Co). As an example, only Co is mentioned.

U.S. Pat. No. 1,831,567 discloses a cemented carbide with a binder phase of Mn only and U.S. Pat. No. 1,815,613 with a binder phase of Manganese-steel.

SE 71064 discloses a metal alloy containing essentially tungsten carbide with at least 15% binder metal of a manganese steel.

### OBJECTS AND SUMMARY OF THE INVENTION

It is an object of this invention to avoid or alleviate the problems of the prior art.

It is also an object of this invention to provide an improved cemented carbide body and a method of making same.

In one aspect of the invention, there is provided a cemented carbide body consisting essentially of WC and from about 3 to less than about 15 wt % of a metal binder phase comprising from about 0.5 to about 15 wt-% Mn, remainder Co.

In another aspect of the invention, there is provided a method of making a cemented carbide body comprising one or more hard constituents and a binder phase based on cobalt by powder metallurgical methods milling, pressing and sintering of powders forming hard constituents and binder phase wherein Mn is present in the binder phase in an amount of from about 0.5 to about 15 wt-% of the binder phase.

### BRIEF DESCRIPTION OF THE FIGURE

FIG. 1 is a scanning electron microscope image in 8000× of the microstructure of a cemented carbide according to the invention.

### DETAILED DESCRIPTION OF THE PREFERRED EMBODIMENTS OF THE INVENTION

It has been found that additions of Mn to the binder phase of cemented carbide strengthen the WC/WC grain boundaries and results in products with an improved resistance to plastic deformation.

The present invention relates to a cemented carbide body containing from about 3 to less than about 15 wt-%, preferably from about 5 to about 12 wt-%, binder phase and essentially WC as the remainder in which the binder phase further contains from about 0.5 to about 15, preferably from about 1 to less than about 10 wt-% Mn. The WC content is preferably from about 80 to about 97 wt-%. A body according to the invention may further contain up to about 10 vol-% additional phases such as γ-phase.

In one embodiment, the cemented carbide body has a binder phase enriched surface zone.

In another embodiment, the cemented carbide body has a submicron WC grain size.

In still another embodiment, the cemented carbide body is provided with a wear resistant coating as is conventional in the art.

The cemented carbide body can be used as a cutting tool for metal machining, a button for rock drilling applications or a wear part.

The present invention also relates to a method of making a cemented carbide body comprising one or more hard constituents and a binder phase based on cobalt by powder metallurgical methods milling, pressing and sintering of powders forming hard constituents and binder phase whereby Mn in an amount of from about 0.5 to about 15 wt-% of the binder phase is added.

The advantages offered by the manganese additions are as mentioned an element that segregates to the WC/WC grain boundaries and thereby strengthens them by means of the increase in work of separation.

The invention is additionally illustrated in connection with the following Examples which are to be considered as illustrative of the present invention. It should be understood, however, that the invention is not limited to the specific details of the Examples.

### EXAMPLE 1

TNMG-160408-PF cemented carbide inserts according to the invention and reference inserts were made from powder mixtures with the compositions:
Composition 1: 0.5 wt-% Mn, 5.5 wt-% Co, remainder 0.2 μm WC
Composition 2: 0.5 wt-% Mn, 5.5 wt-% Co, remainder 0.8 μm WC
Composition 3: 0.5 wt-% Mn, 5.5 wt-% Co, remainder 2 μm WC
Reference: 6 wt-% Co, remainder 2 μm WC

The mixtures were wet milled in a ball mill, spray dried, compacted to inserts and sintered.

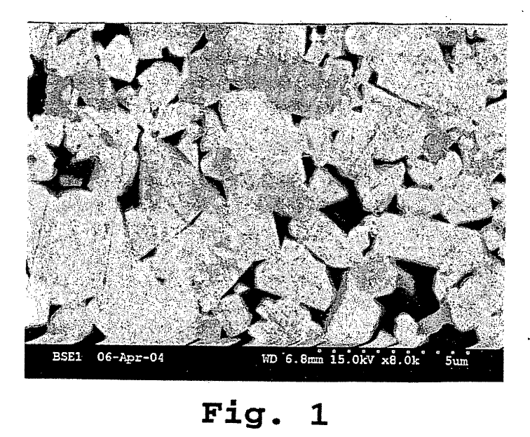

The material according to Composition 3 had a hardness of 1450 HV. The microstructure is shown in FIG. 1.

The reference insert also had a hardness of 1450 HV.

### EXAMPLE 2

Inserts of composition 3 and reference were tested with regard to resistance to plastic deformation. Inserts according to the invention showed 25% better resistance to plastic deformation than the reference.

The principles, preferred embodiments and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art without departing from the spirit of the invention.

What is claimed is:

1. A cpemented carbide body consisting essentially of WC and from about 3 to less than about 15 wt-% of a metal binder phase comprising from about 0.5 to about 15 wt-% Mn, remainder Co.

2. The cemented carbide body of claim 1 wherein said binder phase comprises from about 1 to less than about 10 wt-% Mn.

3. The cemented carbide body of claim 1 wherein the binder phase content is present in an amount of from about 5 to about 12 wt-%.

4. The cemented carbide body of claim 1 wherein said cemented carbide further contains up to about 10 vol-% additional phases.

5. The cemented carbide body of claim 1 having a binder phase enriched surface zone.

6. The cemented carbide body of claim 1 wherein said body has a submicron WC grain size.

7. The cemented carbide body of claim 1 having a wear resistant coating.

8. The cemented carbide body of claim 1 wherein said body is a cutting tool for metal machining.

9. The cemented carbide body of claim 1 wherein said body is a button for rock drilling applications.

10. The cemented carbide body of claim 1 wherein said body is a wear part.

11. A method of making a cemented carbide body comprising one or more hard constituents and a binder phase based on cobalt by powder metallurgical methods milling, pressing and sintering of powders forming hard constituents and binder phase wherein Mn is present in the binder phase in an amount of from about 0.5 to about 15 wt-% of the binder phase.
